(19) United States
(12) Patent Application Publication
(10) Pub. No.: US 2006/0222073 A1
(43) Pub. Date: Oct. 5, 2006

(54) Authoring running marks in compressed data

(76) Inventors: Guillaume Mercier, Bourlon (FR); Hee-Yong Kim, Glen Allen, VA (US)

Correspondence Address: DAVID GROSSMAN, 518 WOODLAND CT. NW, VIENNA, VA, 22180, US

(21) Appl. No.: 11/391,244

(22) Filed: Mar. 29, 2006

Related U.S. Application Data
(60) Provisional application No. 60/665,845, filed on Mar. 29, 2005.

(51) Int. Cl. H04N 7/12

(52) U.S. Cl. 375/240.12

(57) ABSTRACT

Authoring at least one Running Mark in a compressed data stream is taught. The compressed data stream is preprocessed to decompress frames. The decompressed frames may be decoded and stored in a memory. In addition, one or more encoding parameters for each decoded frame may be stored in the memory. The decoded frames may be processed for Running Mark insertion. From among these frames, at least one candidate frame is determined and selected for Running Mark insertion. For each selected, at least one candidate macroblock is determined and selected. One or more Running Marks may be inserted into the selected candidate macroblocks for creating a Running Mark macroblock. At least one link connected to at least one of the Running Mark macroblocks may be modified. The modification may generate modified frames, which in turn, may be reconstructed for display.

### CROSS REFERENCE TO RELATED APPLICATIONS

The present application claims the benefit of provisional patent application Ser. No. 60/665,845 to Mercier, filed on Mar. 29, 2005, entitled “H.264 Compatible Running Marks,” which is hereby incorporated by reference.

### BRIEF DESCRIPTION OF THE DRAWINGS

FIG. 1 shows an embodiment of I and P frames as referenced frames for motion compensation.

FIG. 2 shows an embodiment of decoding an MPEG-2 input data stream and storing B frame compression parameters in arrays.

FIG. 3 shows an embodiment of analyzing B frames for Running Mark insertion and generating a new MPEG-2 stream.

FIG. 4 shows an embodiment of building H.264 compression information arrays for I, P and B frames.

FIG. 5 shows an embodiment of modifying Bm and Bn to form B′m and B′n.

FIG. 6 shows an embodiment of deriving a 4×4 DCT RM pattern from 8×8 DCT carriers constructed by Watson's model.

FIG. 7 shows an embodiment of a flow diagram for authoring at least one Running Mark in a compressed data stream.

FIG. 8 shows another embodiment of a flow diagram for authoring at least one Running Mark in a compressed data stream.

FIG. 9 shows yet another embodiment of a flow diagram for authoring at least one Running Mark in a compressed data stream.

FIG. 10 shows an embodiment of a data stream reconstruction system.

FIG. 11 shows another embodiment of a data stream reconstruction system.

FIG. 12 shows yet another embodiment of a data stream reconstruction system.

FIG. 13 shows a link between a Running Mark macroblock and a referencing macroblock.

FIG. 14 shows an embodiment of reconstructing H.264 compressed data stream with Running Marks.

### DETAILED DESCRIPTION

This disclosure deals with a reconstructive approach to minimize quantization errors with Running Marks.

Running Marks Overview

A Running Mark (“RM”) is defined as a virtually invisible mark that may be added into video content and that may change each time video content is played. In the generalized, descriptive and/or plural sense, RM can be denoted as RMs.

As one way to thwart piracy of video content, RMs may be added into a compressed digital data stream. These marks may form a “source-of-copying message” for enabling the tracing of the source of an unauthorized copy of an information-bearing medium, such as a compact disc (“CD”), digital video disc (“DVD”) or digital broadcasting. This message may occur in the context of a video stream produced in an MPEG domain. Alternatively, it may be in other formats, such as being in combination with an audio signal or software using similar principles. Generally, these marks may not be visible or be intrusive to a viewer, but may be detected and decoded by hardware maintained by an authorized user.

The message may identify a multitude of content items. These items include, but are not limited to, serial numbers of a particular playback unit, a particular original storage medium (e.g., CD, DVD, flash drive, etc.) and playback time. Significantly, this message may be uniquely produced at the playback unit each time the medium is played. By playing the medium (that may have been pirated from an authorized copy) and decoding the message embedded in the marks added to the video stream, the authorized user may be able to trace the copyist.

RMs are different from watermarks. Once created at the point of authoring, RMs may have the ability to change. Watermarks, however, usually do not change once created at the point of authoring.

RMs may comprise blocks of pixels distributed strategically in video stream within selected frames. However, RMs might not appear at the same location in successive frames to avoid perceptibility by the viewer. RM positions in a frame may correspond to message hole (“MH”) locations, defined by place holder sectors. Each place holder sector may contain replacement data (e.g., in the form of blocks, pixels, etc.). The contents of the pixel blocks (e.g., pixels) at MH locations may represent RMs.

MH locations are MPEG segments (e.g., MPEG-1, MPEG-2, MPEG-4, H.264, etc.) that represent data bits, which may be found in an MPEG video stream. Each MH may correspond to one or more macroblocks of a picture frame that may be changed for bit modulation. Address offsets may be provided to identify MH locations in a frame.

RMs may represent a logic “1” or a logic “0”. Such representation may depend upon whether or not pixels at each MH location are changed from the original image content. This standard may be reversed or encoded in a different format, such as in quad data instead of binary data. As one example, if a MH contains a block of pixels changed from the original image content of the block, the message content may be decoded as an RM of value “1”. If the pixel block corresponding to the MH location is not changed when compared to the original image at that location, the message content may be decoded as an RM of value “0”. These logic 1s and 0s may be read successively, within the frame, and then frame by frame to assemble the complete message corresponding to the source of copying.

The architecture of RMs may uniquely separate three discrete functions: mark creation, mark placement and mark insertion. By separating out these discrete functions, RMs may achieve a number of critical advantages, including but not limited to, invisibility, recoverability, renewability, flexibility, and cost-effectiveness. The flexible pre-processing algorithm combined with a high number of message mailboxes relative to message bits may deliver virtually invisible marks that pirates would not be able to directly attack. The marks may be resilient to piracy attacks, ranging from the simplest to the most complex. Examples of such attacks include, but are not limited to, compression/re-compression and image distortions (like cropping and rotating), random noise injections, collusion attacks, etc.

The architecture may also permit extensive signal processing, including error correction and spread spectrum coding for ensuring a highly robust system. The algorithms for mark placement and creation may be easily updated without any impact on the mark inserter function in fielded units. RMs may be inserted multiple times in the delivery chain, thus creating an audit trail for tracking pirated content to its source. Insertion of RMs may be a very efficient process and may only require minimal resources to implement. For instance, when implemented within a consumer DVD player, the RM inserter adds no hardware costs to the player. For a further description of RMs, one may refer to U.S. Pat. No. 6,285,774B1 (“'774 patent”).

RMs and MPEG-2

RMs may be inserted into Moving Pictures Expert Group-2 (“MPEG-2”) compressed bit streams. Published by the International Organization for Standardization (“ISO”) in conjunction with the International Electrotechnical Commission (“IEC”) as the international standard ISO/IEC 13818 on Dec. 31, 2004, MPEG-2 is a designation of a group of coding standards for digital audio and video. For example, MPEG-2 may be used for encoding audio and video broadcasting signals, such as direct broadcast satellite and cable, or be used as the coding format for DVDs.

MPEG-2 may be used the generic coding of moving pictures and associated audio and the creation of a video stream. This standard may support two types of video streams: progressive scan and interlaced video streams. In progressive scan video streams, the basic unit of encoding is a frame. In interlaced video streams, the basic unit of encoding is either a field or a frame.

According to ISO/IEC 13818, a frame in progressive scan video streams is defined as containing lines of spatial information of a video signal. These lines “contain samples starting from one line instant and continuing through successive lines to the bottom of the frame.” Essentially, all lines of a frame may be displayed in one pass.

In contrast, a frame in interlaced video streams is defined as having two fields, namely a top field and a bottom field. A field is defined as the assembly of alternate lines of a frame. One of these fields (top or bottom) is likely to commence one field later than the other.

Overall, the output of the decoding process for progressive scan video streams is a series of reconstructed frames. The output of the decoding process for interlaced video streams is a series of reconstructed fields.

Video streams may be created using three types of frame data. These frame data are intra-coded frames, forward predictive frames and bipredictive (bidirectional) frames. Respectfully, each may be termed I-frame (also known as I-picture), P-frame (also known as P-picture) and B-frame (also known as B-picture).

An I-frame may be encoded without prediction. In other words, it is encoded without reference to any picture except itself. I-frame is a single frame of digital content that a compressor examines, independent of preceding and subsequent frames. Often, the I-frame may be used for random access and as references for the decoding of other frames/pictures. Additionally, it generally stores all the data needed to display the frame. Usually, I-frames may be interspersed with P-frames and B-frames in a compressed video.

A P-frame may be encoded with prediction from previous frames. It generally follows an I-frame, and contains only data that have changed from the preceding I-frame. Examples of changes include, but are not limited to, color and content changes. Often, P-frames may be dependent on I-frames to fill in data.

A B-frame may be encoded with prediction using frames from both previous and subsequent frames. It normally contains only data that either have changed from the preceding frame or are different from the subsequent frame.

Prediction is defined as the use of a predictor (i.e., a linear combination of previously decoded pel values or data elements) to provide an estimate of the pel value or data element currently being decoded. Pel, short for pixel or picture element, is a digital sample of the color intensity values of a picture at a single point. Data element is an item of data as represented before encoding and after decoding.

Typically, frames/pictures may be segmented into macroblocks. A macroblock is defined as the basic unit of the encoding and/or decoding process. Prediction types may be selected on a macroblock basis rather than on the entire frame/picture itself.

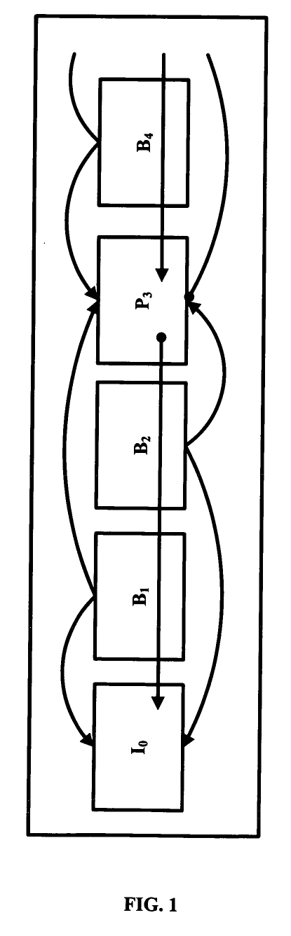

In MPEG-2 compressed bit streams, RMs may be inserted into B-frames. Typically, B-frames are not referenced during motion compensation reconstruction of any other frame of the stream. In contrast, as illustrated in FIG. 1, I-frames and P-frames tend not to be good candidates because both may be used as reference frames for motion compensation. Thus, any changes made to I-frames and/or P-frames may lead to uncontrolled changes or difficult to control changes that may propagate to other neighboring frames.

Authoring RMs in MPEG-2 may involve a three step process: (1) decoding the MPEG-2 stream, (2) locating and building RM macroblocks and (3) regenerating a modified MPEG-2 stream while keeping as much data from the original stream as possible.

In the beginning, inputted MPEG-2 stream may be decoded. As one embodiment, once this data is received, the data may be decoded by applying the Huffman coding scheme to quantized discrete cosine transform (“DCT”) coefficients. Huffman coding is an entropy coding algorithm used for lossless data compression. Moreover, it attempts to achieve the shortest possible average code word length for a source by using a variable-length code table for encoding a source symbol (such as a character in a file), where the variable-length code table has been derived in a particular way based on the estimated probability of occurrence for each possible value of the source symbol.

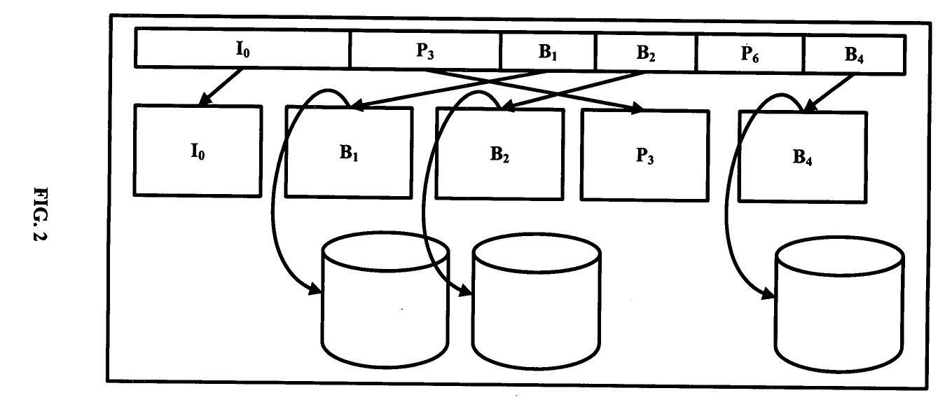

In addition to decoding, B-frames and compression parameters may be stored in arrays, as shown in FIG. 2. Compression parameters include, but are not limited to, quantizer scales, motion vectors, slice header locations, DCT coefficients, etc. These arrays may be used to regenerate compressed B-frames without having to go through a complete MPEG-2 encoding, which could degrade video quality.

Each B-frame may then be analyzed for locating macroblocks of the frame that may serve as RM macroblocks. Among those that are identified, some macroblocks may be selected as RM carriers. An RM carrier is defined as a macroblock carrying MPEG bits in an MH, as well as the corresponding pixel values of the macroblock. Since an RM may have to carry information to represent a logic “0” and/or a logic “1”, two slightly different versions of each RM macroblock may be built. These new macroblocks may have different DCT coefficients but keep the same number of bits.

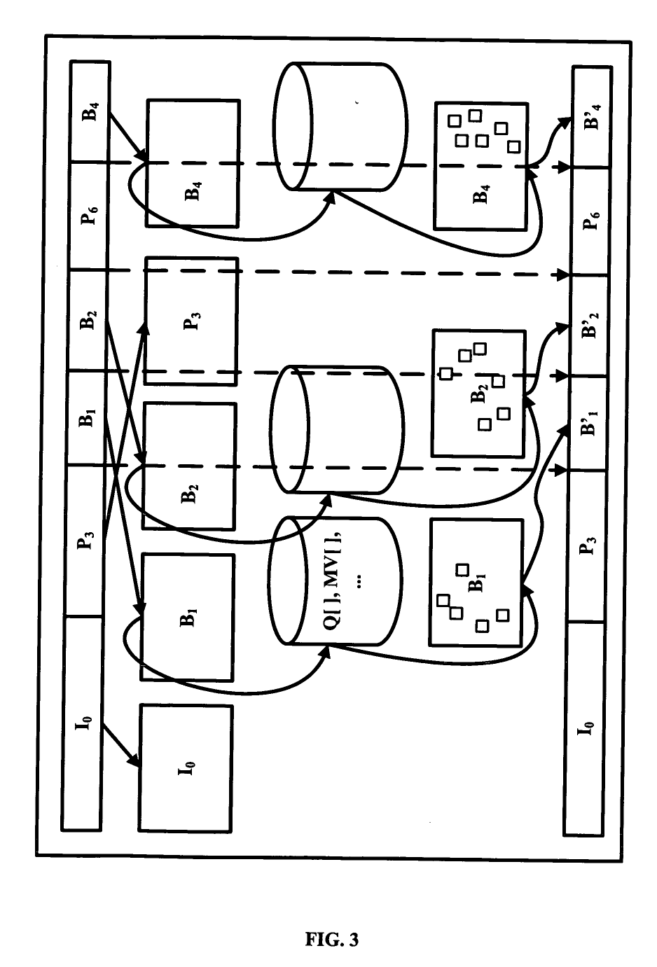

Finally, as depicted in FIG. 3, a new MPEG-2 stream may be generated. Compressed MPEG-2 data from I-frames and P-frames may need to be exact copies of the compressed data of the same I-frames and P-frames from the original stream. B-frames may be reconstructed using information stored in the arrays. However, each RM macroblock may be created separately so it may be inserted in place inside the compressed MPEG-2 stream later in time. Preparing for off-line insertion may have a couple of impacts on compressed B-frame reconstruction. One, the compressed B-frame may be slightly larger, and quantizer scales of other macroblocks may need to be increased so that the newly compressed B-frame size is identical to the original compressed B-frame size. To achieve exact size matching, bit and byte padding may be used. Two, RM macroblocks may need to be identical in size to facilitate replacement and may need to be independent from the following macroblocks so that no artifacts appear when RM macroblocks are replaced in the compressed stream. To prevent artifacts from appearing, a slice header may be placed immediately after each RM macro block.

RMs and Other Compressed Data

RMs may also be inserted into compressed data streams encoded in H.264. H.264 is also known as MPEG-4 Part 10, published by the ISO/IEC as the international standard ISO/IEC 14496-10 on Dec. 12, 2005.

However, when compared to MPEG-2, insertion of RMs may be different under H.264 and similar variants, such as MPEG-4, DivX, etc. For example, while a change in a B frame may be safe in MPEG2 because the error made by RM insertion may not propagate to other frames, it may not be the case for H.264. As a reason, any I-frame, P-frame or B-frame may become a reference frame in H.264.

Moreover, entropy coding may be more efficient in H.264 than MPEG-2. Yet, just like MPEG-2, variable length codes (VLC), quantizer scales and motion vectors, and the content adaptive parameter may need to be reset after a slice header. Resetting may permit the use of the same macroblock replacement system, as described in the '774 patent.

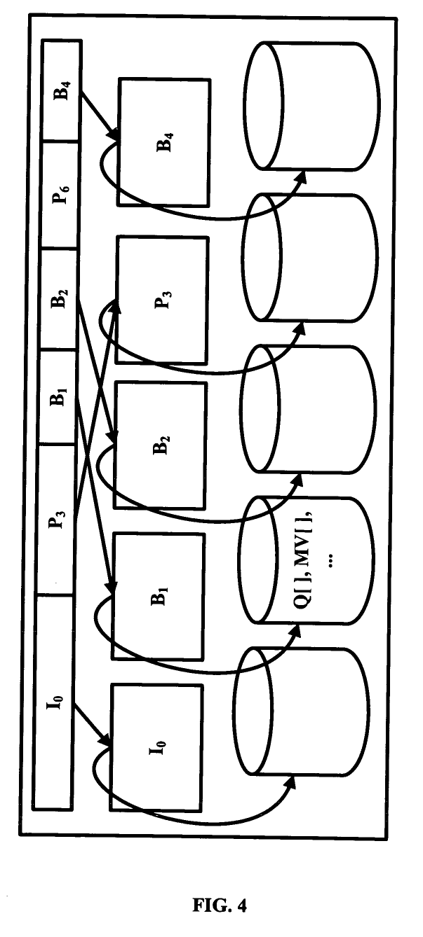

Since B-frames can be referenced, creating RMs by changing the macroblock's pixels in a B-frame and adding a noise pattern may lead to error propagation of the noise pattern to neighboring frames. By analyzing the motion vectors of these frames, it can be determined which macroblocks may be referenced to an RM macroblock. This operation may require that H.264 compression information arrays are built not only for B-frames, but also for I-frames and P-frames, as illustrated in FIG. 4.

Once the compression information arrays are built, it is possible to reconstruct an H.264 bit stream similar to the input stream. Depending on the entropy coding algorithm, the resulting stream could differ. Nevertheless, as an embodiment, encoded video output should be close to the decoded video of the original stream. Rather than reconstructing only B-frames as in MPEG-2, reconstructing each frame may compensate for changes made to any frame. This kind of reconstruction may remove an uncontrolled error propagation problem. When changing a macroblock that is referenced by motion compensation from another macroblock, the error difference may be coded into the stream using the residual DCT coefficients. The number of bits for a reconstructed frame may likely be larger since the prediction error to code may likely increase.

Besides a quantizer scale change, further bit reduction may be possible with a new motion estimation of any macroblock. This new motion estimation (such as reconstructing a frame with one or more new motion vectors) may lead to a better prediction. A basic frame recompression (equivalent to the MPEG-2 B-frame quantizer scale increase of MPEG-2 RMs) may be applied to keep the same size of each frame. This recompression may lead to slight picture quality degradation as an effect of keeping the same data rate when adding noise to the video.

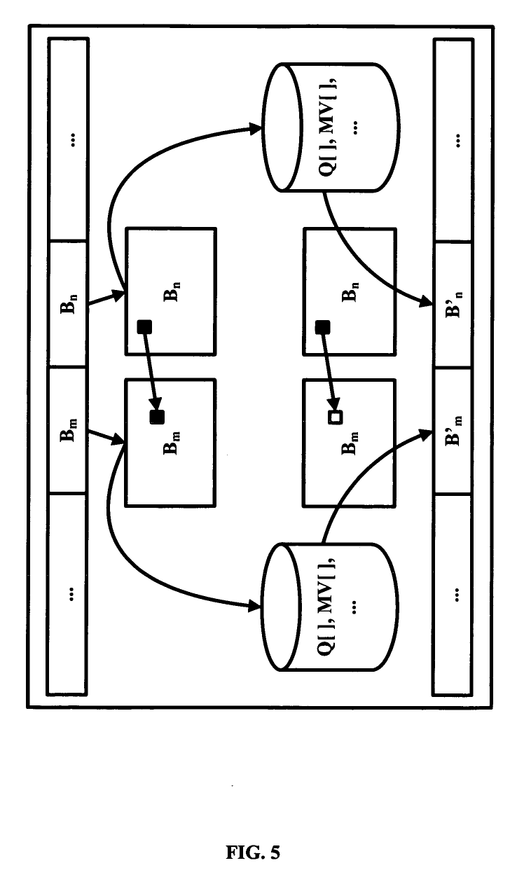

As exemplified in FIG. 5, Bm is modified to form B′m. However, since each frame of the data stream may be reconstructed, Bn may need to be recoded. Recoding may be achieved by performing motion estimation from B′m instead of Bm. This action should result in a proper presentation of Bn. Otherwise, the difference between Bm and B′m would not likely have been taken into account when presenting Bn.

RMs in MPEG-2 may be built by adding (or subtracting) a noise pattern to 8×8 DCT blocks. This noise pattern may come from a psychovisual model. One embodiment is Watson's Just Noticeable Difference (“JND”) in 8×8 DCT, which may tell how much each DCT coefficient can be changed without any noticeable differences. However, H.264 may use both 8×8 and 4×4 DCT integer transforms. DCT coefficients for an H.264 compressed data stream may be determined psychovisually. If there is a good psychovisual model for 4×4 DCT, it can dictate RM carrier noise. As an alternative to a 4×4 DCT psychovisual model, the 4×4 DCT may adapt to parameters in Watson's 8×8 DCT model. Another alternative is deriving a 4×4 DCT RM pattern from 8×8 DCT carriers constructed by Watson's model.

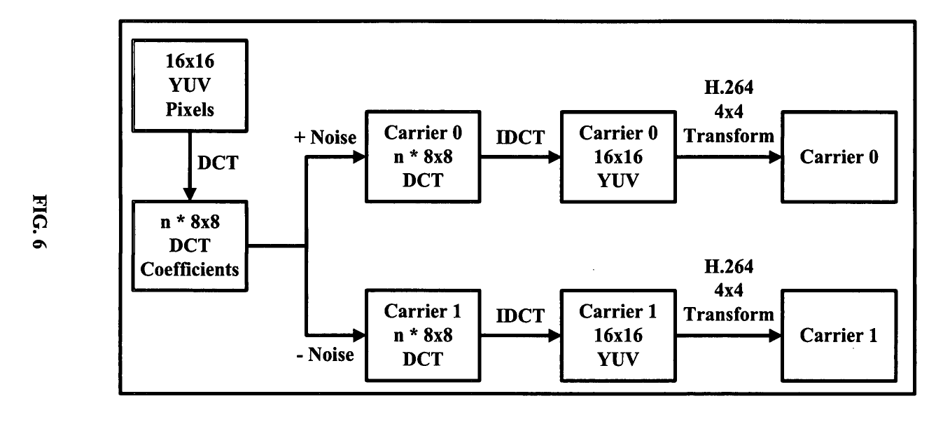

FIG. 6 shows the second alternative model. As shown, 16×16 YUV pixels of each macroblock may be available. With such availability, an appropriate noise pattern required to generate RMs carriers may be built by applying an 8×8 DCT. These carriers can then be converted back into the YUV pixel domain, where the H.264 4×4 transform may be applied. Application may occur after motion compensation has been completed. The resulting macroblocks may be used as H.264 RMs carriers, provided they are encoded properly to provide the ability to be interchanged seamlessly.

In addition to RMs noise, image recompression required to fit a bit budget (such as when the goal is to keep the same number of bits for a frame) may introduce another kind of noise, namely quantization noise, because of larger quantization scale. Quantization noise may propagate uncontrollably because of motion compensation. If a macroblock from a neighboring picture references a macroblock in a frame that has been slightly recompressed, the quantization noise may be carried along. By reconstructing each and every picture of the H.264 stream, this quantization noise propagation may be inherently stopped. Since every frame may be reconstructed and the residual may be recomputed, the quantization noise may remain under control. The quantization noise error may be taken into account while reconstructing the referencing macroblocks. After motion compensation, the residual may contain the noise difference, which may be encoded instead of being ignored.

RMs Authoring in Compressed Data

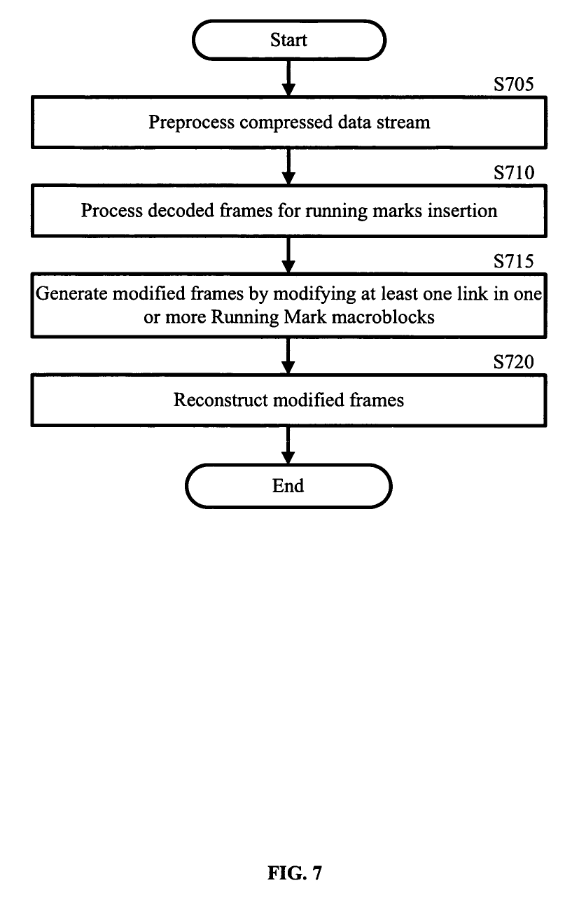

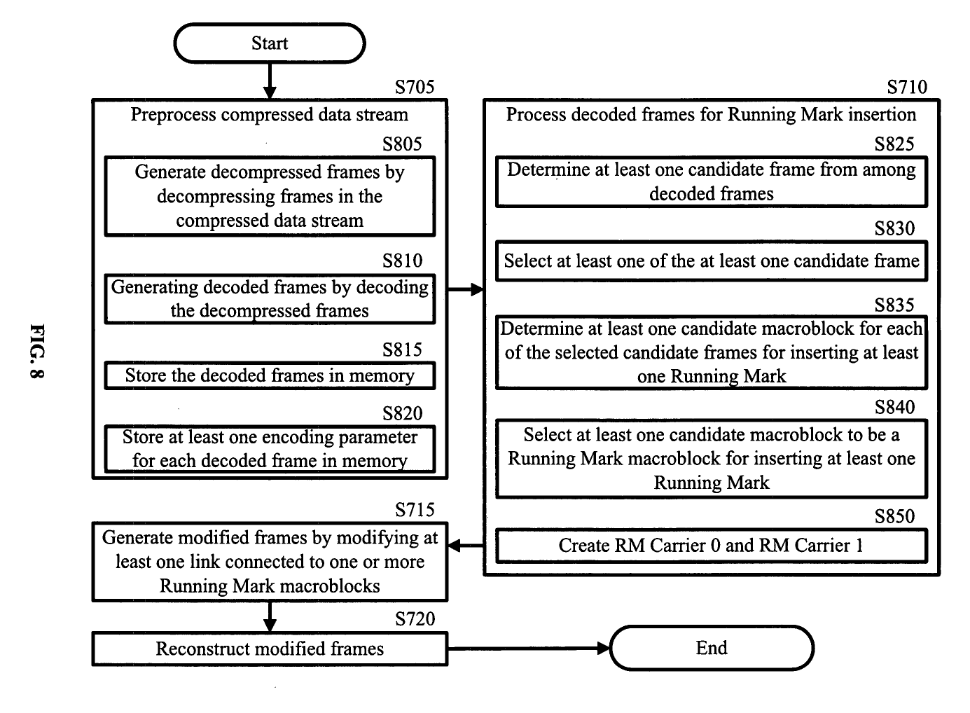

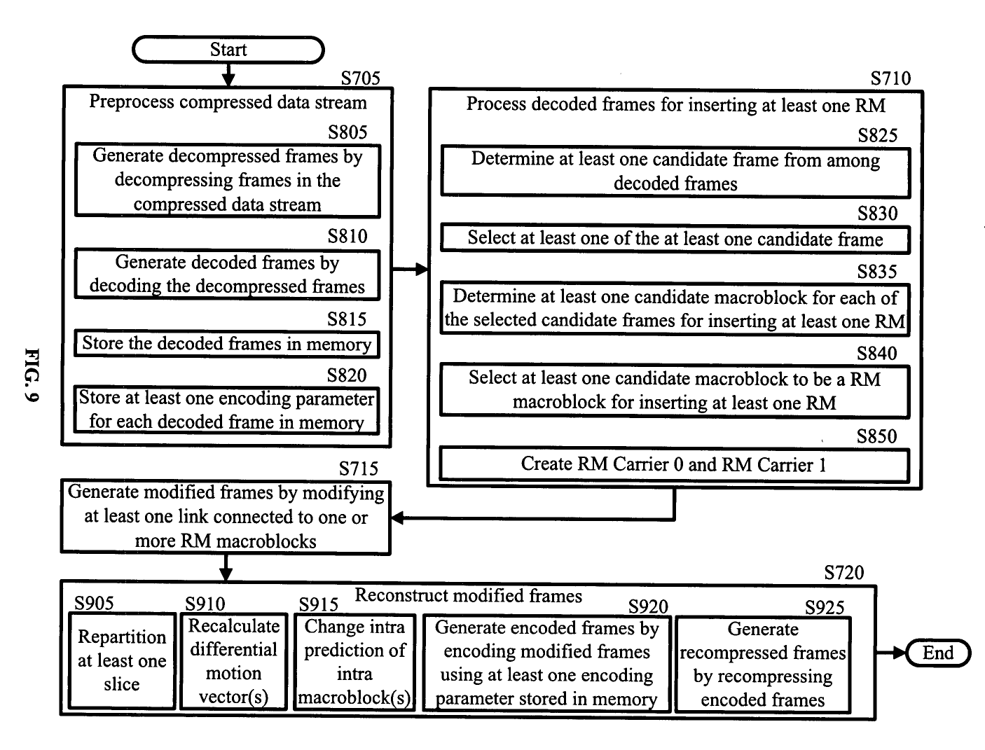

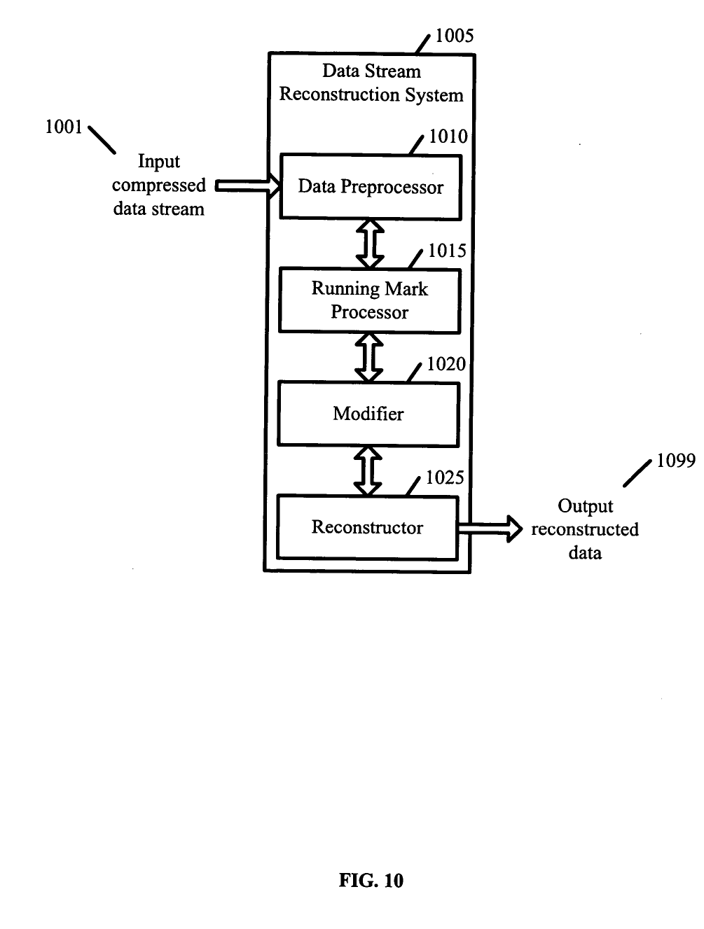

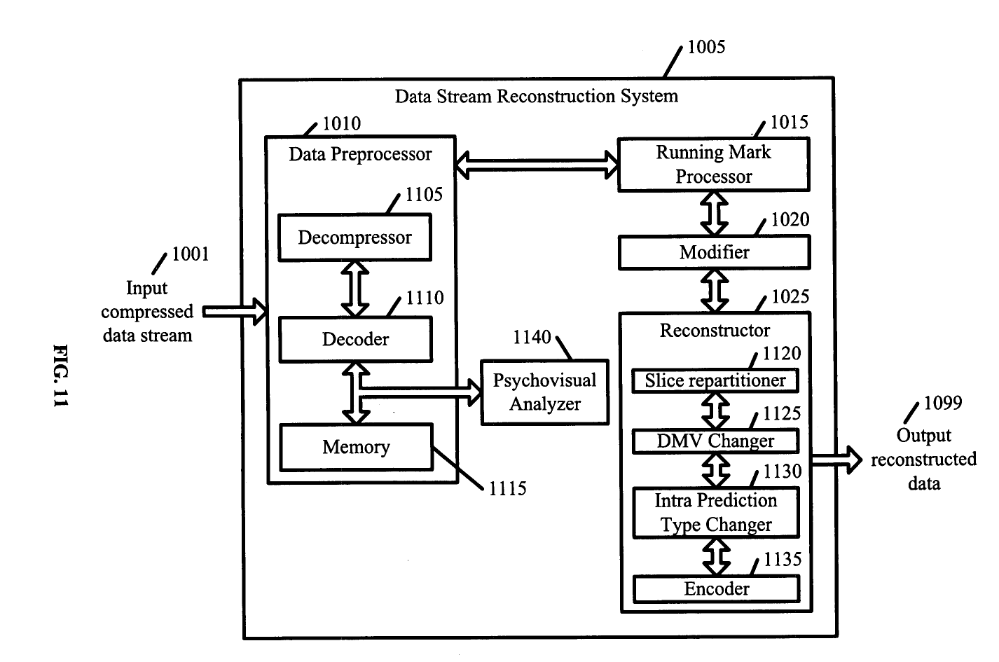

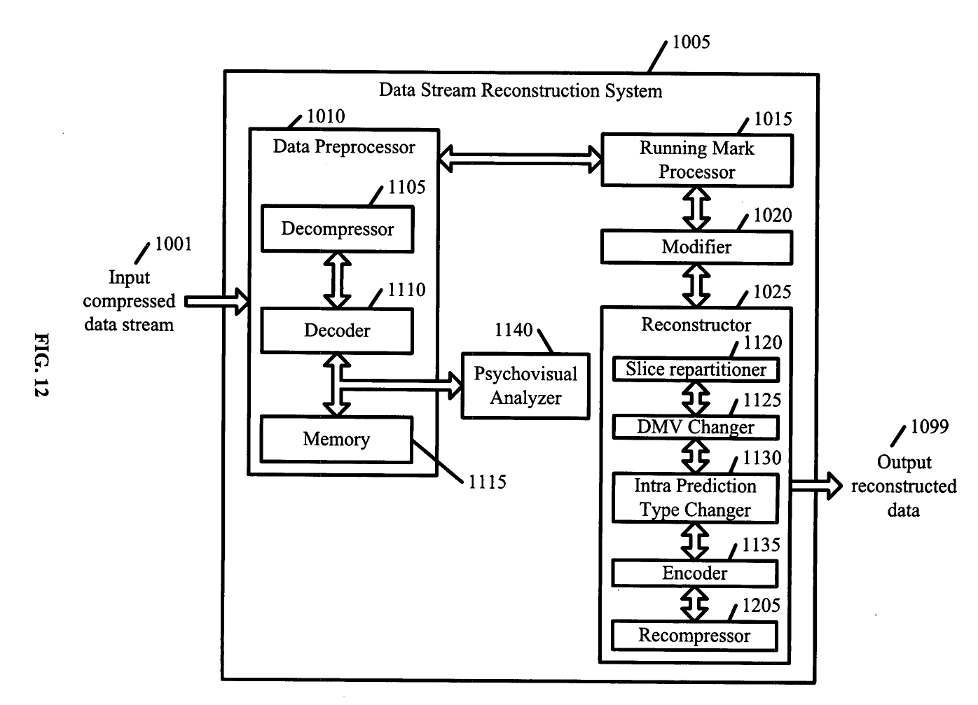

FIGS. 7, 8 and 9 show embodiments of an overall flow diagram of authoring RMs in a compressed data stream. Similarly, FIGS. 10, 11 and 12 show embodiments of an overall block diagram of authoring RMs in a compressed data stream.

The compressed data stream may be carried in any video stream. As an embodiment, the video stream may be an H.264 encoded signal stream. In addition to H.264, the scope of this disclosure is intended to also cover encoded signal streams similar to H.264. Similar variants are video codecs, including advanced video codecs, that are generic, MPEG-4 based, and/or Microsoft Windows Media Video (WMV) based. Examples of MPEG-4 based variants include, but are not limited to, MPEG-4, H.26x (where x<4), 3ivx, DivX, XviD, etc. Examples of WMV based variants include, but are not limited to, VC-1, WMV7, WMV8 and WMV9. Other similar variants may even include competitors of the MPEG-4 variants and WMV based variants, such as Sorensen codec and Theora.

In general, compressed data stream may be inputted 1001 into a data stream reconstruction system 1005 to insert RMs. This system 1005 may preprocess and process this data stream for inserting one or more RMs. After insertion, the data may be reconstructed, and thereafter, outputting reconstructed data 1099.

Compressed data may be reconstructed with RMs by preprocessing the compressed data stream S705 using a data preprocessor 1010. In preprocessing, a decompressor 1105 may be used to generate decompressed frames by decompressing frames in the compressed data stream S805. Decompression may occur one or more frames at a time. Using a decoder 1110, decoded frames may be generated by decoding the decompressed frames S810. While decompressed frames may be decoded one or more frames at a time, it is an embodiment that they be decoded one frame at a time. One or more decoded frames may be stored in a memory S815, 1115. These frames may be stored until they have been reconstructed. Also, one or more encoding parameters (e.g., motion vectors, etc.) for each decoded frame may be stored in the memory S820, 1115. These parameters may be used later to allow reconstruction of the compressed bit stream of each frame.

Once stored, the decoded frames may be processed for RM insertion S710 using an RM processor 1015. Processing may include determining one or more candidate frames from among the decoded frames S825. From among those determined, one or more candidate frames may be selected S830. For each of the selected candidate frames, one or more candidate macroblocks may be determined for RM insertion S835. From among those that are determined for RM insertion, one or more candidate macroblocks may be selected to be a RM macroblock(s) for inserting one or more RMs S840.

Each frame considered for RM insertion may undergo a psychovisual analysis via a psychovisual analyzer 1140 to determine one or more candidate macroblocks for RM insertion. Each of these candidate macroblocks may result in the creation of two distinct macroblocks—Carrier 0 and Carrier 1 S850. Carrier 0 is a macroblock that carries a logic “0”. Carrier 0 tends to represent content in a macroblock that is identical to content in the original image. Carrier 1 is a macroblock that carries a logic “1”. Carrier 1 tends to represent content in a macroblock that is changed in comparison with the original image.

As previously described, the noise profile of MPEG-2 RMs may be re-used to generate these carriers. Other rules may be applied to select a good candidate macroblock. Examples of such rules include, but are not limited to, (1) avoiding screen edges to increase the survivability to video cropping and copying, (2) avoiding the amount of information in the macroblock that is reused for surrounding macroblocks (i.e., intra prediction) or previous/future frames (i.e., inter prediction), (3) using transitions or textured regions, etc.

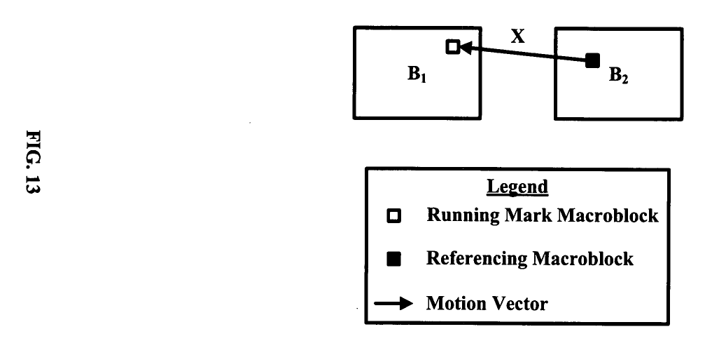

When a candidate macroblock is selected for RM insertion, one or more links (e.g., motion vectors) to this RM macroblock may need to be broken, as shown in FIG. 13. For example, an RM macroblock may be linked to a macroblock in a future frame (e.g., a referencing macroblock). If the macroblock in a future frame uses part of the RM macroblock for motion compensation, then either the motion vector may need to be changed to avoid referencing any part of RM macroblocks or the prediction error due to RM addition may need to be compensated. The latter may be referred to as drift compensation. The reason is that when an RM carrier is inserted, the video will likely change. Thus, to prevent any propagation of the change, it is an embodiment to break the links.

By modifying (e.g., changing, breaking, etc.) at least one link connected to one or more RM macroblocks, modified frames may be generated S715. This modification may be achieved by using a modifier 1020.

Generally, the bit stream for each modified frame may need to be reconstructed S720 after RM insertion because, as a possible effect, new slices may be introduced in a picture. If this case occurs, one or more slices may need to be repartitioned S905. For example, consider a picture having 10 macroblocks and 2 slices, where each slice includes at least one macroblock. The first slice comprises macroblocks 1-5; the second slice comprises macroblocks 6-10. If a RM is inserted into macroblock 3, thus creating a RM macroblock, then a new slice needs to be inserted after this RM macroblock. Consequently, the first slice changes from having macroblocks 1-5 to macroblocks 1-3. The new inserted slice comprises macroblocks 4-5. The second slice becomes a third slice.

Repartitioning may be accomplished by using a slice repartitioner 1120. Hence, modification may be necessary to present the picture with RMs correctly S715. Proper display may require the modified frames to be reconstructed S720. Reconstruction may be accomplished using a reconstructor 1025.

Reconstruction may include using information previously stored in memory 1115. In particular, this information includes one or more of the encoding parameters for encoding the modified frames. The modified frames may also be reconstructed using one or more new motion vectors.

The encoding parameters may be reset in the beginning of the slice. Additionally, intra prediction may have to be in the same slice. Moreover, motion vectors may be differentially coded. Motion vector prediction may be derived from motion vectors of previously encoded neighboring blocks. Because of new slices, a previously encoded neighbor block may not be available since it may be in a different slice. If the previous encoded neighbor block is in a difference slice, a different motion vector prediction may result. The differential motion vectors (“DMV”) may have to be recalculated based on new motion vector prediction S910. Recalculation may be achieved by using a DMV changer 1125. Also, intra prediction of certain intra macroblocks may have to be changed since the introduction of new slices would likely make unavailable the previously available neighbor block that is used as prediction S915. The intra prediction may be changed using an intra prediction type changer 1130.

To illustrate this point, consider this example. A current macroblock was an intra macroblock. It may have used the previously encoded neighboring macroblock, for example, on the top of the current one, as the prediction. If there is an RM macroblock between the current and previously encoded macroblocks, these two macroblocks would be in different slices. Therefore, the current macroblock would not be able to use the previously encoded neighboring macroblock as prediction. In essence, the current macroblock should be changed to another possible prediction type.

Encoding the modified frames with one or more encoding parameters may be accomplished by using an encoder 1135. As a result, encoded frames may be generated S920.

To maintain the original bit rate and/or frame sizes of the original compressed data stream, some frames (e.g., the encoded frames) may need to be recompressed. If necessary, recompression may be accomplished using a recompressor 1205 to generate recompressed frames by recompressing the encoded frames S925. The recompressor 1205 may be part of or be included in the reconstructor 1025.

Recompression may be accomplished by changing the quantization scale in the encoder 1135 either locally as a macroblock level or globally as a whole picture level. Effecting such change, information previously stored in arrays during the first stage (e.g., decompression) may be used.

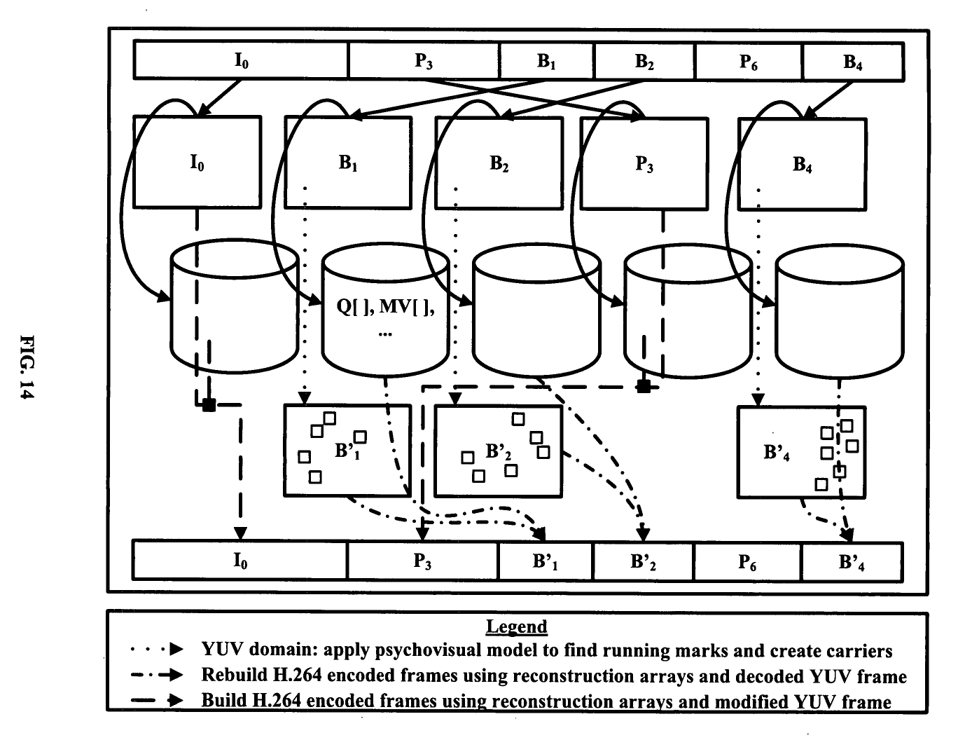

In the reconstruction stage, motion vectors and macroblock types may already have been determined. The stream may need to be created by (1) subtracting, from the YUV pixels of a macroblock, the blocks pointed by the motion vectors, (2) applying the 4×4 or 8×8 integer transform, (3) quantizing the results, and (4) generating the entropy coded bit stream. If no change is made to YUV pixels, the regenerated stream (i.e., H.264 or similar variant) may be identical or be very close, to the original stream. Moreover, the regenerated data stream may show little to no video degradation, as shown in FIG. 14. It is important to note that FIG. 14 is drawn with respect to simplicity. While FIG. 14 shows RMs in B frames, RMs can also be generated for I and P frames.

Apart from entropy coding, reconstruction is generally not very CPU intensive since the original motion estimation is reused. When the number of bits for a frame is larger than it originally was and needs to be recompressed, if any of its motion vectors had to be removed because it was referencing a macroblock having an RM, then it is possible to perform a new motion estimation for this particular macroblock. More advanced encoding techniques may also be used to reduce the quality loss introduced during the recompression of some of the frames. An example of an advanced encoding technique is changing the reference frame if the reference frame contains many RMs. Another example is changing a neighboring frame that may have low motion sections.

Once each of the modified frames is reconstructed after the frames are no longer in a decoded picture buffer, each of the decoded frames in memory that corresponds to its modified frames may be deleted from the memory. Deletion may occur at any time, starting as early as when one modified frame is being reconstructed. The decoder may be configured for performing this deletion process.

The foregoing descriptions of the embodiments of the disclosure have been presented for purposes of illustration and description. They are not intended to be exhaustive or be limiting to the precise forms disclosed, and obviously many modifications and variations are possible in light of the above teaching. The illustrated embodiments were chosen and described in order to best explain the principles of the disclosure and its practical application to thereby enable others skilled in the art to best utilize it in various embodiments and with various modifications as are suited to the particular use contemplated without departing from the spirit and scope of the disclosure. In fact, after reading the above description, it will be apparent to one skilled in the relevant art(s) how to implement the disclosure in alternative embodiments. Thus, the disclosure should not be limited by any of the above described example embodiments.

In addition, it should be understood that any figures, graphs, tables, examples, etc., which highlight the functionality and advantages of the disclosure, are presented for example purposes only. The architecture of the disclosed is sufficiently flexible and configurable, such that it may be utilized in ways other than that shown. For example, the steps listed in any flowchart may be reordered or only optionally used in some embodiments.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the disclosure in any way.

Furthermore, it is the applicants' intent that only claims that include the express language “means for” or “step for” be interpreted under 35 U.S.C. § 112, paragraph 6. Claims that do not expressly include the phrase “means for” or “step for” are not to be interpreted under 35 U.S.C. § 112, paragraph 6.

### REFERENCES

Frank Hartung and Bernd Girod, “Watermarking of Uncompressed and Compressed Video”, 66 Signal Processing 283-301 (1998).

A. B. Watson, “Perceptual Optimization of DCT Color Quantization Matrices,” IEEE International Conf. on Image Processing, Austin, Tex. (November 1994).

H. A. Peterson, A. J. Ahumada, and A. B. Watson, “An improved Model for DCT Coefficients Quantization,” 1913 Proceedings of SPIE 191-201 (1993).

A. B. Watson, “DCT Quantization Matrices Visually Optimized for Individual Images,” 1913 Proceedings of SPIE 202-216 (1993).

What is claimed is:

1. A method of authoring at least one Running Mark in a compressed data stream comprising:
a. preprocessing said compressed data stream, said preprocessing comprising:
i. generating decompressed frames by decompressing frames in said compressed data stream;
ii. generating decoded frames by decoding said decompressed frames;
iii. storing said decoded frames in a memory; and
iv. storing at least one encoding parameter for each of said decoded frames in said memory;
b. processing said decoded frames for Running Mark insertion, said processing comprising:
i. determining at least one candidate frame from among said decoded frames;
ii. selecting at least one of said “at least one candidate frame”;
iii. determining at least one candidate macroblock for each of said candidate frame that is selected; and
iv. selecting said at least one candidate macroblock to be a Running Mark macroblock for inserting at least one Running Mark;
c. generating modified frames by modifying at least one link connected to at least one of said Running Mark macroblock; and
d. reconstructing said modified frames.

2. A method according to claim 1, wherein said compressed data stream is carried in an H.264 encoded signal stream.

3. A method according to claim 1, wherein said compressed data stream is at least one of the following:
a. MPEG-4;
b. VC-1;
c. Microsoft Windows Media Video; and
d. Sorensen.

4. A method according to claim 1, wherein said link is broken.

5. A method according to claim 1, further including repartitioning at least one slice.

6. A method according to claim 1, further including recalculating at least one differential motion vector.

7. A method according to claim 1, further including changing the intra prediction of at least one intra macroblock.

8. A method according to claim 1, further including generating encoded frames by encoding said modified frames with at least one encoding parameter.

9. A method according to claim 8, further including generating recompressed frames by recompressing said encoded frames.

10. A method according to claim 1, further including deleting at least one of said decoded frames from said memory that corresponds to at least one of said modified frames after said “at least one of said modified frames” is reconstructed.

11. A method according to claim 1, wherein said compressed data stream is decompressed and decoded in increments of at least one frame at a time.

12. A method according to claim 1, wherein said decoded frames are analyzed with psychovisual analysis, said psychovisual analysis resulting in a Carrier 0 and a Carrier 1.

13. A method according to claim 1, wherein said modified frames are reconstructed with at least one new motion vector.

14. A method according to claim 1, wherein DCT coefficients of said compressed data stream are determined psychovisually.

15. A system for authoring at least one Running Mark in a compressed data stream, comprising:
a. a data preprocessor, said data preprocessor including:
i. a decompressor configured for generating decompressed frames by decompressing frames in said compressed data stream;
ii. a decoder configured for generating decoded frames by decoding said decompressed frames; and
iii. a memory configured for:
1. storing said decoded frames; and
2. storing at least one encoding parameter;
b. a Running Mark processor configured for:
i. determining at least one candidate frame from among said decoded frames;
ii. selecting at least one of said “at least one candidate frame”;
iii. determining at least one candidate macroblock from each of said candidate frame that is selected; and
iv. selecting said at least one candidate macroblock to be a Running Mark macroblock for inserting at least one Running Mark;
c. a modifier configured for generating modified frames by modifying at least one link connected to at least one of said Running Mark macroblock; and
d. a reconstructor configured for reconstructing said modified frames.

16. A system according to claim 15, wherein said compressed data stream is decompressed and decoded in increments of at least one frame at a time.

17. A system according to claim 15, wherein said compressed data stream is carried in an H.264 encoded signal stream.

18. A system according to claim 15, wherein said compressed data stream is at least one of the following:
a. MPEG-4;
b. VC-1;
c. Microsoft Windows Media Video; and
d. Sorensen.

19. A system according to claim 15, wherein said link is broken.

20. A system according to claim 15, wherein said reconstructor includes a slice repartitioner.

21. A system according to claim 15, wherein said reconstructor includes a DMV changer configured for recalculating at least one differential motion vector.

22. A system according to claim 15, wherein said reconstructor includes an intra prediction type changer configured for changing the intra prediction of at least one intra macroblock.

23. A system according to claim 15, wherein said reconstructor includes an encoder, said encoder configured for encoding said modified frames with said at least one encoding parameter.

24. A system according to claim 23, wherein said reconstructor further includes a recompressor configured for recompressing said modified frames that are encoded.

25. A system according to claim 15, wherein said decoder is configured for deleting at least one of said decoded frames from said memory that corresponds to at least one of said modified frames after said “at least one of said modified frames” is reconstructed.

26. A system according to claim 15, further including a psychovisual analyzer configured for analyzing said decoded frames, said analyzing resulting in a Carrier 0 and a Carrier 1.

27. A system according to claim 15, wherein said modified frames are reconstructed with at least one new motion vector.

28. A system according to claim 15, wherein DCT coefficients of said compressed data stream are determined psychovisually.
